(19) United States
(12) Patent Application Publication
(10) Pub. No.: US 2008/0252134 A1
(43) Pub. Date: Oct. 16, 2008

(54) Wheel Rim Cover

(75) Inventor: Russell Lunn, Staffordshire (GB)

Correspondence Address: SMITH-HILL AND BEDELL, P.C., 16100 NW CORNELL ROAD, SUITE 220, BEAVERTON, OR, 97006, US

(73) Assignee: ALLOY WHEEL PROTECTION SYSTEMS LIMITED, Stafford, Staffordshire (GB)

(21) Appl. No.: 12/066,693

(22) PCT Filed: Sep. 13, 2006
(86) PCT No.: PCT/GB06/03387

§ 371 Date: Mar. 13, 2008

(30) Foreign Application Priority Data
Sep. 16, 2005 (GB) 0518938.6

(51) Int. Cl. B60B 7/01

(52) U.S. Cl. 301/37.24

(57) ABSTRACT

A wheel rim cover comprises an arc-shaped member sized and shaped to fit at least over a portion of the outer rim edge, the cover extending at least from the edge over an outer most portion of the rim which, in use, is exposed; and the cover further comprises a bend around the edge to secure the cover onto the rim edge.

### FIELD OF THE INVENTION

The invention relates to wheel rim covers and kits of wheel rim covers.

### BACKGROUND TO THE INVENTION AND PRIOR ART KNOWN TO THE APPLICANT

Automatic tyre changing machines so called “tyre changers” are often used to remove tyres from alloy rims. Many such devices exist in the market place such as those sold under the brands Ravaglioli and Oma. These essentially have a rotatable table onto which the wheel as a tyre and alloy rim combination is placed and secured in position. An arm is then lowered with a D-shaped head onto the edge of the rim and the tyre and rim are rotated whilst the head causes the outer ply to be separated from the alloy rim edge. The head enters into contact with the edge of the rim. Tyre fitters who change a large number of tyres per day submit the apparatus to rigorous use whereby the heads become worn and tend to occasionally and if the head is not replaced which is often the case, frequent alloy rim damage occurs which is not desirable in the eyes of the customer. The only way to remove the scratches is then often to submit the alloy rim to a form of re-coating or other repair routine which will then cause the treated rim to stand out when compared with the set of other vehicle wheels of a particular user. The re-coating of alloys or the repair of alloys amounts to considerable costs as well as generating badwill for those responsible of fitting tyres. In practice, the vehicle will have to be fitted with spare wheels whilst the alloy repair takes place. In order to reduce the risk of scratching the automatic tyre changers' manufacturers recommend frequent replacements of the heads or at least replacing the rubber pads which are sometimes used on the D shaped heads.

With the increasing number of alloy wheels available, an immediately deployable system without requiring the replacement of these conventional tyre changers is required.

### SUMMARY OF THE INVENTION

In its broadest independent aspect, the invention provides a wheel rim cover comprising: an arc shaped member sized and shaped to fit at least over a portion of the outer rim edge, the cover extending at least from the edge over an outermost portion of the rim which, in use, is exposed; and the cover further comprises a bend around the edge to secure the cover onto the rim edge.

This combination of features is particularly advantageous because it protects the edge of the rim from scratching during the operation of removing the tyre from the rim. It also does not interfere with the removal of the tyre so that conventional automatic tyre changers may be used. This cover may also be used for the manual removal of tyres from the rim, if necessary, as it will offer improved protection of the outer rim. It will avoid having to recoat rims which are damaged during the conventional tyre removal process.

In a subsidiary aspect in accordance with the invention's broadest independent aspect, the wheel rim cover further comprises clamping means to clamp the cover onto the rim. In this configuration, the wheel rim cover can be prevented from rotating about the rim which could otherwise cause undue wear and tear to the cover itself as well as to the protected rim.

In a further subsidiary aspect, the arc forms a circle where the circle has a gap between two circle end pieces and the cover incorporates a mechanism for immobilising the two end pieces relative to one another, thereby clamping the cover onto the rim. This method of clamping is particularly advantageous because it removes any requirement for clamping to, for example, external surfaces such as the tyre changing machinery or the wheel itself.

In a further subsidiary aspect, the inner surface of the cover is a layer with low abrasion properties compared to conventional steel. This configuration will provide the inner surface with sufficiently low abrasion to avoid any scratching of the edge whilst the cover is in place.

In a further subsidiary aspect, the inner surface of the cover has relatively high friction properties and the outside of the cover has relatively low friction properties. This may, for example, be achieved by employing rubber in the inside surface and steel on the outside surface so that the removing head of a tyre changer may be freely displaced against the cover on the outside whilst the cover itself is immobilised due to the high friction of an inside layer against the rim edge.

In a further subsidiary aspect, the invention provides a kit of wheel rim covers according to any of the preceding aspects.

The provision of a kit will allow a particular fitter to employ a range of covers to correspond with a range of rim sizes.

In a further subsidiary aspect, the covers are of varying sizes and are colour-coded according to their sizes. This will allow the tyre fitter to immediately find which wheel cover to employ for a given rim. These features will be particularly beneficial when considering that in the field of wheel fitters any improvement to the rapidity of a fitter being able to find the appropriate tool will allow greater efficiencies to be achieved.

In a further subsidiary aspect, end portions of the arc are drawn together by a mechanism which is supported on two plates located within the arc and separated by a gap.

In a further subsidiary aspect, both the arc and the plates incorporate inner surfaces with low abrasion properties.

In a further subsidiary aspect, a tongue located on one of the plates cooperates with a loop located on the other plate in order to align the end portions of the arc.

### BRIEF DESCRIPTION OF THE FIGURES

FIG. 1 shows a wheel rim cover in perspective view.

FIG. 2 shows a cross-sectional view along line AA′.

FIG. 3 shows an alternative embodiment of the invention using a ¾ arc. The figure shows a plan view of the embodiment.

FIG. 4 shows a further embodiment of the invention with a cover in plan view

### DETAILED DESCRIPTION OF THE FIGURES

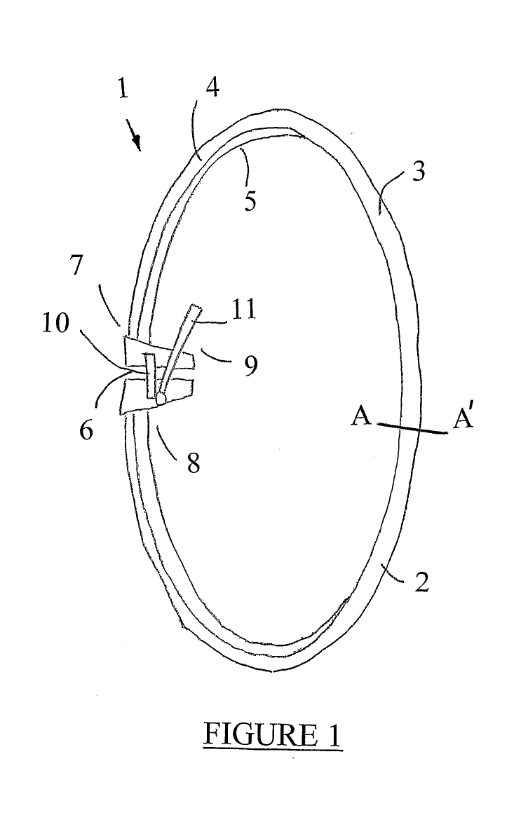

FIG. 1 shows a wheel rim cover generally referenced 1 with an arc shaped member in the form of a circle 2. The cover has an approximate C-shaped cross section. The ring or circle shaped member incorporates a peripherally extending bend 3 with an upper portion 4 and a lower portion 5 on either side of the bend. The upper portion 4 is such that it covers an outer most portion of the rim when the cover is placed on the rim. The lower portion 5 is such that it protects the outer edge of the rim as well as the immediate underneath of the outer edge. This configuration also effectively allows the cover to be snugly fitted onto the edge.

The cover may be made of steel or any other appropriately hard material. On the inside of the cover, between upper and lower portions 4 and 5, a layer of low abrasion and high friction material may be provided such as a layer of rubber-like material so that the cover grips the edge of the rim without the cover tending to rotate about the rim edge.

A gap 6 is provided between end extremities 7 and 8 of the cover allowing the cover to be adjusted for fine variations in rim diameter. Gap 6 also provides the cover with sufficient resilience so as to be more readily fitted onto the rim edge. In addition a closing member 9 may be provided to clamp the cover onto the rim once the cover is placed into position. The closing mechanism may be selected from known alternatives by the person skilled in the art. The configuration presented incorporates a bar 10 for limiting the amount by which the gap 6 may be opened. A lever 11 may be secured against extremity 9 so as to prevent the rim cover loosening during use.

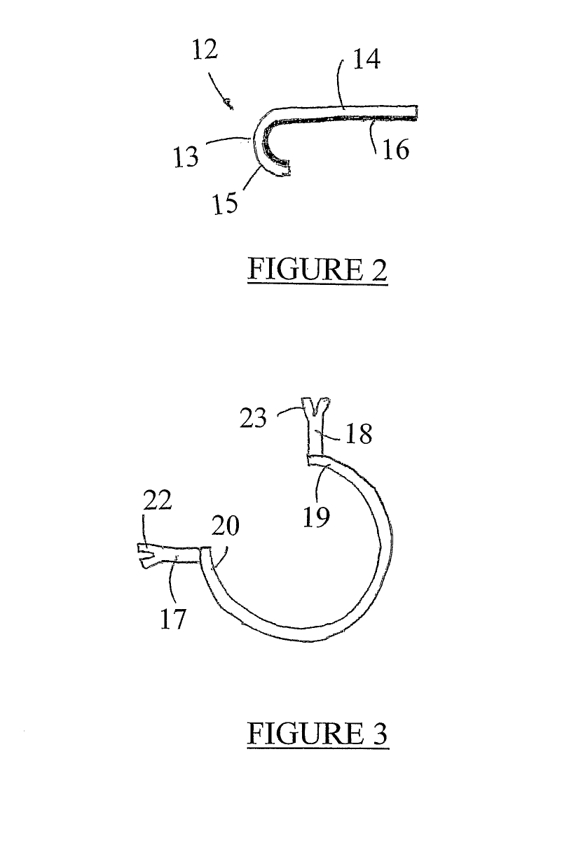

FIG. 2 shows cover portion 12 with a bend 13 and an upper portion 14 and a lower portion 15. The upper portion 14 is of greater length than the lower portion 15 in order to cover a greater outer most portion of the rim. The inside of the cover is provided with a rubber-like layer 16.

The invention also envisages the use of an entirely resilient rim cover so that the cover may be sized and shaped to allow a stretch fit onto the edge of a rim. Any appropriate elastic material may be selected from known alternatives by the person skilled in the art.

FIG. 3 shows a cover with an arc covering only ¾ of the periphery of the edge of the rim. Arms 17 and 18 located at arc extremities 19 and 20 incorporate end clamps 21 and 22 for securing the cover onto a neighbouring support structure. Whilst the arm 17 is shown as extending radially outwards, the invention also envisages the arm extending radially inwards so as to be attached to the wheel rim with a fitting which will avoid any abrasion of the rim occurring.

The above wheel covers may be packaged and used as a kit of for example ten ring-shaped covers ranging from 13 inches to 22 inches to accommodate wide variations in rim sizes.

Once the rim cover is in place a conventional head of an automatic tyre changing machine may be employed to run against the cover as it removes the tyre from the rim. It is understood that the cover is of the kind which is tough enough to resist the force of a conventional head of an automatic tyre changing machine running against the cover without the head perforating the cover. The cover may receive surface damage during use whilst fulfilling its protective duty instead of the alloy wheel but the outer surface of the cover may be of relatively low friction to reduce wear and tear so that the wheel cover may be used for several tyre removal operations.

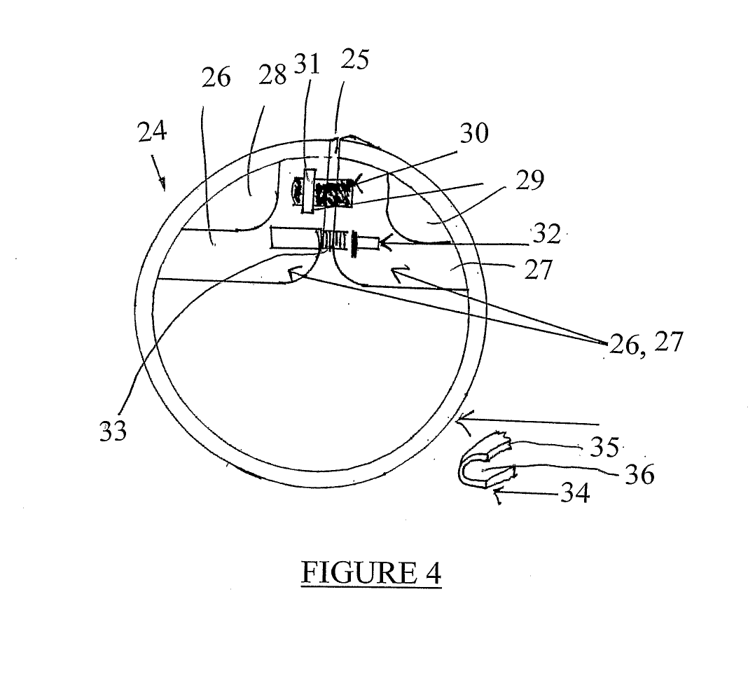

FIG. 4 shows a further embodiment of the invention where the cover 24 has a single opening 25 in its ring. In cross-section the ring is C-shaped as shown in cross-sectional view 34. Plates 26 and 27 project from an upper portion 35 of the cover. These are L-shaped in plan view with optional cut-out portions 28 and 29 between the plates and the cover's outer portion. A tongue 30 is attached or part of plate 27 and projects across gap 25 in order to insert into loop 31 which acts as a guide for tongue 30. The plates 26 and 27 may be drawn together and secured tightly on a wheel rim by locating the edge of the rim into receiving portion 36 and tightening spring loaded latch which uses a spring 33 to resiliently shut the latch and draw the plates together. Both the inside of the ring and the underside of the plates may be covered with low abrasive material with high frictional properties relative to the surface of an alloy wheel.

1-11. (canceled)

12. A wheel rim cover comprising an arc shaped member sized and shaped to fit in use at least over a portion of an outer rim edge of a wheel rim, the coyer extending at least from the edge over an outermost portion of the rim which, in use, is exposed; the cover further comprising a bend around the edge to secure the cover onto the rim edge.

13. A wheel rim cover according to claim 12, further comprising clamping means to clamp the cover onto the rim.

14. A wheel rim cover according to claim 12, wherein the cover comprises clamping means, the arc shaped member is in the form of a circle, the circle has a gap between two circle, end pieces and the clamping means includes a mechanism for immobilising the two end pieces relative to one another, thereby clamping the cover onto the rim in use.

15. A wheel rim cover according to claim 12, wherein the inner surface of the cover is a layer with low abrasion properties compared to conventional steel.

16. A wheel rim cover according to claim 12, wherein the inner surface of the cover has relatively high friction properties and the outside of the cover has relatively low friction properties.

17. A wheel rim cover according to claim 12, wherein the arc shaped member includes end portions which are drawn together by a mechanism which is supported on two plates located within the arc and separated by a gap.

18. A wheel rim cover according to claim 12, wherein the arc shaped member includes end portions which are drawn together by a mechanism which is supported on two plates located within the arc and separated by a gap, and both the arc shaped member and the plates incorporate inner surfaces with low abrasion properties.

19. A wheel rim cover according to claim 12, wherein the arc shaped member includes end portions which are drawn together by a mechanism which is supported on two plates located within the arc shaped member and separated by a gap, and o tongue located on one of the plates cooperates with a loop located on the other plate in order to align the end portions.

20. A kit of wheel rim covers in which each wheel rim cover is according to claim 12.

21. A kit of wheel rim covers in which each wheel rim cover is according to claim 12, and the covers are of varying sizes and are colour coded according to their sizes.
